(19) United States
(12) Patent Application Publication
(10) Pub. No.: US 2009/0099277 A1
(43) Pub. Date: Apr. 16, 2009

(54) Radiation curable and jettable ink compositions

(76) Inventors: Devdatt S. Nagvekar, Hamilton, OH (US); Matthew M. Ellison, Mason, OH (US); Daniel A. Wilson, Cincinnati, OH (US)

Correspondence Address: HEXION SPECIALTY CHEMICALS, INC., 12650 Directors Drive, Suite 100, Stafford, TX, 77477, US

(21) Appl. No.: 11/973,919

(22) Filed: Oct. 11, 2007

(51) Int. Cl. C08L 31/00; C08G 18/06; C08L 75/04; C08L 33/08

(52) U.S. Cl. 522/153; 526/72; 526/301; 526/319; 526/213; 526/224; 526/194; 524/556

(57) ABSTRACT

The present invention is directed to radiation curable and jettable ink compositions and particularly to such compositions which exhibit enhanced elongation, when cured at low doses, and are advantageously used, for example, in digital inkjet printing. The compositions include a polyfunctional component and a monofunctional monomer, and may optionally include an additional monofuctional component and/or chain transfer agent. The compositions have a viscosity at 25° C. of not greater than about 70 cP and are radiation curable to form a cured ink having an elongation of between about 40 and about 150%. In addition, the compositions, when cured at low dose, exhibit a tack free surface and a low coefficient of friction.

### FIELD OF THE INVENTION

The present invention is directed to radiation curable and jettable ink compositions and particularly to such compositions which exhibit enhanced elongation, when cured at low doses, and are advantageously used, for example, in digital inkjet printing.

### BACKGROUND OF THE INVENTION

Various radiation curable, and particularly ultraviolet (UV) light curable, ink compositions are known in the art. By nature, UV curable inks are primarily thermoset systems. The thermoset nature of these materials makes it difficult to formulate inks that exhibit enhanced elongation upon curing, as demonstrated by the Instron test. This difficulty can be alleviated to a degree by using high molecular weight oligomers which can improve the elongation of UV cured materials. However, the addition of high molecular weight oligomers increases the viscosity of the liquid materials which prohibits their use in jettable applications in where viscosities are typically below 70 cPs at 25° C. While solvent-based, air cured jettable inks have been proposed, where the viscosity of the polymer or oligomer is reduced with a solvent, such inks require unpractical drying times and can be unfriendly to the environment due to high volatile organic component content.

Other considerations are also important in formulating inks to satisfy numerous criteria affecting ink performance and stability. For example, the inks must possess an appropriate level of surface tension, low volatility, low smear, high image quality (especially at high print speeds), and adhesion to a variety of substrate materials. Stability of the inks is also important, including storage stability, stability at high shear rates, stability at high temperatures, and stability at the extreme conditions inside a print head, e.g. a piezoelectric or thermal head. Also desired is the elimination of volatile solvents from the inks. Current commercially available UV curable inkjet inks are limited in one or more of these areas.

US Pub. No. 2006/0222831 discloses curable ink compositions comprising an oligomeric component, which has a molecular weight of more than about 10,000 g/mole and which does not contain radiation curable ethylenically unsaturated functionality, a diluent, additives, and a mono-functional monomer having a molecular weight of 100 g/mol to 600 g/mol. US Pub. No. 2006/0275588 is a Continuation-in-Part of US Pub. No. 2006/0222831, and discloses curable ink compositions additionally comprising an acrylic polymer or copolymer having an acid number of below about 20. The compositions of the present invention differs from these disclosures in that they do not include the described high molecular weight non-reactive oligomer, do not require the presence of a solvent and, by contrast, the oligomer component included in the compositions of the invention, contains radiation curable, ethylenically unsaturated functionality.

Accordingly, a need exists for further improvements in radiation curable and jettable inks.

### SUMMARY OF THE INVENTION

The present invention is directed to radiation curable and jettable ink compositions.

In one embodiment, the invention is directed to a radiation curable and jettable ink composition which include a polyfunctional component which is an oligomer containing polyfunctional ethylenically unsaturated radiation curable groups, an ethylenically unsaturated monofunctional monomer, and optionally additional ethylenically unsaturated monofunctional component and/or chain transfer agent. The composition is substantially free of solvent, has a viscosity at 25° C. of not greater than about 70 cP, preferably not greater than about 50 cP and more preferably not greater than 35 cP, and is radiation curable to form a cured film having an elongation of at least about 40% to about 150%.

In another embodiment, the invention is directed to a radiation curable and jettable ink composition which comprises a polyfunctional component which is preferably an acrylate oligomer containing polyfunctional ethylenically unsaturated radiation curable groups, at least 1 wt. % of a monofunctional acrylate, a colorant, and optionally an additional ethylenically unsaturated radiation curable monofunctional component. The composition is substantially free of solvent, has a viscosity at 25° C. of not greater than about 70 cP, has a static surface tension at 25° C. of not greater than about 40 dynes/cm, and is radiation curable to form a cured film having an elongation of at least about 40% to about 150%.

In another embodiment, the invention is directed to a radiation curable and jettable ink composition which comprises a polyfunctional component which is an acrylate oligomer containing polyfunctional ethylenically unsaturated radiation curable groups, a monofunctional acrylate monomer, a colorant, and optionally an additional ethylenically unsaturated monofunctional component and/or chain transfer agent. The composition is substantially free of solvent, has a viscosity at 25° C. of not greater than about 70 cP, and is radiation curable to form a cured film having an elongation of at least about 40% to about 150%.

In another embodiment, the ink compositions of the invention are substantially free of non-reactive oligomers and preferably substantially free of non-reactive oligomers having a molecular weight of greater than 10,000 g/mole.

In another embodiment, the invention is directed to a radiation curable and jettable ink composition which comprises a polyfunctional component which is a monomer containing 2 or more ethylenically unsaturated radiation curable groups, an ethylenically unsaturated monofunctional monomer, and optionally additional ethylenically unsaturated monofunctional component and/or chain transfer agent. The composition is substantially free of solvent, has a viscosity at 25° C. of not greater than about 70 cP, preferably not greater than about 50 cP and more preferably not greater than 35 cP, and is radiation curable to form a cured film having an elongation of at least about 40% to about 150%.

In another embodiment there is provided a process for preparing a printed article which includes contacting a substrate with an ink composition of the invention. In another embodiment, there is provided a printed article, which includes a substrate and a cured ink composition of the invention.

### DETAILED DESCRIPTION

The present invention is directed to radiation curable and jettable ink compositions which comprise an ethylenically unsaturated polyfunctional component and an ethylenically unsaturated monofunctional monomer. The compositions optionally include an additional ethylenically unsaturated monofunctional component and/or a chain transfer agent. Within the present description “polyfunctional component” refers to a monomer or oligomer component containing two or more functional groups per molecule.

### Polyfunctional Component

The ethylenically unsaturated polyfunctional component suitable for use in the radiation curable ink compositions provides sufficient crosslinking, while also maintaining a low modulus and enhanced elongation in the resulting cured inks. Exemplary polyfunctional components include ethylenically unsaturated oligomers, monomers and combinations thereof, in the following general classes: urethane, polyether, polyester, polycarbonate, polyestercarbonate, acrylic, silicone, and the like, including and any combination or subset thereof. In specific embodiments, the polyfunctional component is an oligomer comprising a urethane backbone, an acrylate oligomer, preferably a urethane hexa-acrylate oligomer, a polyester oligomer, or any combination or subset thereof.

In one embodiment, the polyfunctional oligomer comprises a urethane oligomer including urethane repeating units and two or more ethylenically unsaturated functional groups, which can include, for example, acrylate, methacrylate, allyl, and/or vinyl groups, preferably acrylate and vinyl ether groups. In a more specific embodiment, aliphatic, cycloaliphatic, or mixed aliphatic and cycloaliphatic urethane repeating units are suitable. Urethanes are typically prepared by the condensation of a diisocyanate with a diol. Aliphatic urethanes having at least two urethane moieties per repeating unit are useful, wherein the diisocyanate and diol used to prepare the urethane comprise divalent aliphatic groups that may be the same or different.

Polyester and polyether urethane polyfunctional oligomers functionalized with ethylenic unsaturation are particularly useful. The ethylenic unsaturation may be provided by functional groups such as acrylate, C₁-C₄ alkyl(acrylate) (e.g., methacrylate, ethacrylate, etc.), vinyl, allyl, acrylamide, C₁-C₄ alkyl(acrylamide), and the like groups. The reactive functionality of these urethane acrylates is 2 or greater, preferably 4 or greater, and more preferably 6, reactive groups per oligomer molecule.

Suitable polyether or polyester ethylenically unsaturated urethane polyfunctional oligomers include the reaction product of an aliphatic or aromatic polyether or polyester polyol with an aliphatic or aromatic polyisocyanate that is functionalized with ethylenic unsaturation using a monomer containing the ethylenic unsaturation. Such oligomers may be prepared using procedures well known in the art. The polyether polyol is based on a straight chained or branched alkylene oxide of from one to about twelve carbon atoms, and may be prepared by any method known in the art.

The aliphatic polyisocyanate component contains about 4 to 20 carbon atoms. Exemplary aliphatic polyisocyanates include isophorone diisocyanate; dicyclohexylmethane-4,4′-diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,9-nonamethylene diisocyanate; 1,10-decamethylene diisocyanate; 2,2,4-trimethyl-1,5-pentamethylene diisocyanate; 2,2′-dimethyl-1,5-pentamethylene diisocyanate; 3-methoxy-1,6-hexamethylene diisocyanate; 3-butoxy-1,6-hexamethylene diisocyanate; omega, omega′-dipropylether diisocyanate; 1,4-cyclohexyl diisocyanate; 1,3-cyclohexyl diisocyanate; trimethylhexamethylene diisocyanate; and combinations comprising at least one of the foregoing. Suitable aromatic polyisocyanates include toluene diisocyanate, methylene bis-phenylisocyanate (diphenylmethane diisocyanate), methylene bis-cyclohexylisocyanate (hydrogenated MDI), naphthalene diisocyanate, and the like.

The polyfunctional oligomer may be provided with the ethylenic unsaturation by use of acrylate or methacrylate monomers. Typically the ethylenically unsaturated monomer contains a hydroxyl-terminus. Such monomers include, for example, hydroxyalkyl acrylates or methacrylates such as hydroxyethyl acrylate, hydroxyethyl methacrylate, hydroxypropyl acrylate, hydroxypropyl methacrylate, hydroxybutyl acrylate, hydroxybutyl methacrylate, and the like. In one embodiment, the molar ratio of the polyol, diisocyanate, and ethylenic unsaturation monomer can be approximately 1:2:2.

Examples of suitable polyfunctional urethane acrylate oligomers include, but are not limited to, aliphatic polyester based urethane diacrylate oligomers, examples of which are commercially available from Sartomer Company, Inc. (“Sartomer”) and include those sold under the designations CN991, CN962, CN964, CN966 and CN9893 and those commercially available from Cytec Surface Specialty, (“Cytec”) sold under the designation Ebecryl 1290.

The ink compositions of the invention can suitably contain a mixture of two or more polyfunctional oligomers. In one embodiment, additional oligomer used in combination with an ethylenically unsaturated oligomer as described includes the low viscosity acrylate oligomers described above.

Suitable polyfunctional monomers include, for example, di(meth)acrylates of diols and polyetherdiols, including glycols and polyglycols, such as propylene glycol and polypropylene glycols. Repeating units of glycols including di-, tri- and higher glycols can be used. Other suitable di(meth)acrylates include the di(meth)acrylate of 1,4-butanediol (e.g., SR 213), 1,3-butanediol (e.g., SR 212B), neopentylglycol (e.g., SR 247), propoxylated neopentyl glycol (e.g., SR 9003, a diacrylate of a propoxylated neopentyl glycol), diethylene glycol (e.g., SR 230), hexanediol (e.g., SR 238), dipropylene glycol (e.g., SR 508), tripropylene glycol (e.g., SR 306), triethylene glycol (e.g., SR 272), polyethylene glycol (e.g., SR 259), alkoxylated hexane diols (e.g., CD 560, CD561, CD562, CD563 and CD 564), tetraethylene glycol (SR268) and the like, and di(meth)acrylates available under the trade name SR 9209 (an alkoxylated aliphatic diacrylate). Divinyl and/or diallyl compounds may also be used.

Suitable polyfunctional monomers also include trifunctional ethylenically unsaturated monomers include (meth)acrylate esters of triols, for example trimethylol propane (SR 351), pentaerythritol (SR 444), and the like. Alkoxylated (meth)acrylates can also be used, for example propoxylated and ethoxylated (meth)acrylates such as ethoxylated trimethylol propane tri(meth)acrylates (SR 9035, SR 454, SR 499, SR 502, SR 415), propoxylated trimethylol propane tri(meth)acrylates (SR SR492, CD 501), propoxylated glyceryl tri(meth)acrylates (SR 9020), propoxylated pentaerythritol tri(meth)acrylates, tris(2-hydroxyethyl) isocyanurate tri(meth)acrylate (SR 368), and the trifunctional acrylate ester available from Sartomer under the trade name SR 9012.

Suitable polyfunctional monomers also include tetrafunctional ethylenically unsaturated monomers include, for example alkoxylated (meth)acrylates obtained from tetraols (SR 494), such as ethoxylated pentaerythritol tetra(meth)acrylates (SR 295), and the like.

The ink compositions of the invention can suitably contain a mixture of two or more polyfunctional oligomers and/or monomers as described above.

In another embodiment, in addition to the polyfunctional component described above, the ink composition includes an additional polyfunctional component containing a siloxane backbone, in order to further improve cure, flexibility and/or additional properties of the ink compositions. Examples of such polyfunctional components include CN 9800, available from Sartomer, and Ebecyrl 1360, and Ebecryl 350 available from Cytec.

### Mono-Functional Monomers

The ethylenically unsaturated monofunctional monomer which is employed in the ink compositions of the invention increases chain length of the oligomers and builds molecular weight contributing to enhanced elongation of the cured ink. The ethylenic unsaturation in the ethylenically unsaturated monofunctional monomer may comprise methacrylate, acrylate, vinyl ether, allyl ether, methacrylamide, acrylamide, N-vinyl amide, carbon-carbon double bond, or a combination thereof. In a specific embodiment, the ethylenically unsaturated monofunctional monomer comprises a monofunctional acrylate monomer. In another embodiment, the monofunctional monomer comprises a mixture of two or more monofunctional monomers. In another specific embodiment, the monofunctional monomer comprises a monofunctional acrylate containing a cyclic group, for example a homocyclic group or a heterocyclic group, optionally comprising a fused ring structure. The cyclic group may be aliphatic or aromatic, or the monomer may comprise a combination of such groups. Examples of monofunctional monomers include, but are not limited to, those commercially available from Sartomer under the SR and CD designations, for example, 2(2-ethoxyethoxy) ethyl acrylate (SR 256), tetrahydrofurfuryl acrylate (SR 285), phenoxyethyl acrylate (SR399), alkoxylated nonylphenol acrylate (SR614), isodecyl acrylate (SR 395), 2-phenoxyethyl acrulate (SR 339), isodecyl methacrylate (SR 242), isobornyl acrylate (SR506), alkoxylated tetrahydrofurfuryl acrylate (CD611), trimethylcyclohexane acrylate monomer (CD 420), acrylic esters (CD 277, 278, 585, 586), iso-octyl arcylate (SR440), cyclic trimethylolpropane formal acrylate (SR531), and the like. Others include Laromer TBCH and Laromer DCPA commercially available from BASF Corporation (“BASF”) and Genomer 1122 commercially available from Rahn AG (“Rahn”), vinyl caprolactam (“V-Cap”), vinyl pryrrolidone, and Neodene 16 commercially available from Shell Chemical Co. (“Shell”). In one embodiment, the monofunctional monomer has a Tg (glass transition temperature) of at least 25° C. In further embodiments, the monofunctional monomer has a Tg of at least 40° C., more specifically at least 50° C.

### Optional Monofunctional Component

The ink composition of the invention optionally includes one or more mono-functional acrylate oligomers. Examples of suitable acrylate oligomers include low viscosity acrylate oligomers, for example having viscosities lower than about 5000 cPs, more specifically lower than about 2000 cPs. Examples of commercially available low viscosity acrylate oligomers include, but are not limited to, those available from Sartomer under the CN designation, for example, CN-130 (aliphatic monoacrylate oligomer with a viscosity of 40 cPs at 25° C.), CN-131 (aromatic monoacrylate oligomer with a viscosity of 202 cPs at 25° C.), CN-152 (aliphatic monoacrylate oligomer with a viscosity of 130 cPs at 25° C.), CN-3100 (acrylate oligomer with hydroxyl functionality), and CN2285 (acrylate oligomer).

Examples of suitable polyester oligomers include low molecular weight, low viscosity polyester oligomers, one example of which is R-Gen RD-276, commercially available from Chitech Chemical Company, having a molecular weight of about 1000.

In one embodiment, the oligomer has a molecular weight of up to about 50,000 Daltons, specifically about 500 to about 50,000; more specifically about 1000 to about 40,000; and yet more specifically about 1200 to about 30,000 Daltons. In another embodiment, the oligomer has a molecular weight of less than 10,000 Daltons. In one embodiment, the viscosity of the oligomer is from about 500 cPs to about 100,000 cPs at 60° C., specifically about 1000 to about 65,000 cPs, more specifically about 1000 to about 45,000 cPs.

The ink compositions of the invention can suitably contain a mixture of two or more monofunctional oligomers. In one embodiment, the additional monofunctional oligomer used in combination with the polyfunctional ethylenically unsaturated oligomer, as described, includes the low viscosity acrylate oligomers described above.

In another embodiment, the ink compositions of the invention are substantially free of non-reactive oligomers and preferably substantially free of non-reactive oligomers having a molecular weight of more than about 10,000 g/mole. Specifically, the ink compositions of the invention are free of oligomers which do not contain ethylenically unsaturated radiation curable functional groups and therefore are non-reactive.

In another embodiment, the ink compositions of the invention are free of acrylic polymer or co-polymer having an acid number of below about 20. By acid number it is meant the weight in milligrams of potassium hydroxide required to neutralize the pendant carboxylate groups in one gram of polymer. The procedure for determining acid numbers is described in ASTM D 974 and D 604.

### Optional Chain Transfer Agents

The chain transfer agent may be employed to contribute to the desired low modulus and enhanced elongation of the ink compositions. In one embodiment, the chain transfer agent may comprise one or more acetoacetates, for example, 2-(acetoacetoxy)ethyl acrylate (“AAEA”), acrylic acid 4-(3-oxo-butryloxy)-butyl ester (“AABUA”), 2-(acetoxyacetoxy)ethyl methacrylate (“AAEMA”), 2-(acetoacetoxy)propyl acrylate/2-(acetoacetoxy)isopropyl acrylate mixture (“AAPRA”), thiols, amines or a combination thereof. Suitable thiol containing compounds include but are not limited to isooctylmercaptopropane, 1,2-dimercaptoethane, 1,6-dimercaptohexane, neopentanetetrathiol, and the like, pentaerythritol tetra(3-mercapto propionate), 2,2-bis(mercaptomethyl)-1,3-propanedithiol, and the like, aryl thiol compounds such as 4-ethylbenzene-1,3-dithiol, 1,3-diphenylpropane-2,2-dithiol, 4,5-dimethylbenzene-1,3-dithiol, 1,3,5-benzenetrithiol, glycol dimercaptoacetate, glycol dimercaptopropionate, pentaerythritol tetrathioglycolate, trimethylolpropane trithioglycolate, and the like. In another embodiment, the chain transfer agent comprises a mercapto-functional silicone. More specifically, the chain transfer agent is a silicone containing 2 mole % or greater (mercaptopropyl) methyl siloxane, examples of which include, but are not limited to, SMS-042 from Gelest, Inc. (“Gelest”) and GP-367 from Genessee Polymers Co. (“Genessee”). Such materials are particularly suitable in that the silicone component acts like a surfactant and will orient towards the surface of the ink when deposited. The mercapto groups can react with the ethylenically unsaturated groups of the other components through a thiol-ene reaction. This reaction is generally insensitive to oxygen whereas most free radical polymerizations are inhibited by oxygen. Thus, the preferential migration of the silicone to the surface can improve surface cure and eliminate surface tack by creating a thiol rich zone at the surface where oxygen inhibition would be the greatest.

The ink compositions are preferably substantially non-aqueous, substantially free of a solvent, or substantially free of both, that is, a compound having a boiling point at atmospheric pressure of less than about 120° C. As used herein, substantially non-aqueous means that no water is added to the inks other than the incidental amounts of moisture derived from ambient conditions. Non-aqueous inks can therefore have less than about 3 wt. % of water, more specifically less than about 2 wt. % of water, even more specifically less than about 1 wt. % of water, based on the total weight of the ink. Substantially free of solvents means that the ink contains less than about 20 wt. % of solvent. In more specific embodiments, the ink contains less than about 10 wt. % solvent, more specifically, less than about 5 wt. % solvent, yet more specifically less than about 2 wt. % of solvent, and even more specifically less than about 1 wt. % of solvent, based on the total weight of the ink.

The ink compositions may further contain a colorant which may comprise pigment, dye, or a combination of pigments and/or dyes to provide the desired color. Any pigment, dye or combinations of pigments and dyes can be used, provided that the desired thermal stability of the resulting ink is maintained. The ink is not limited to any particular color. Suitable colors include, for example cyan, magenta, yellow, black, white, orange, green, light cyan, light magenta, violet, and the like. Exemplary pigments include those having the following Color Index classifications: Green PG 7 and 36; Orange PO 5, 34, 36, 38, 43, 51, 60, 62, 64, 66, 67 and 73; Red PR 112, 149, 170, 178, 179, 185, 187, 188, 207, 208, 214, 220, 224, 242, 251, 254, 255, 260 and 264; Magenta/Violet PV 19, 23, 31, and 37, and PR 122, 181 and 202; Yellow PY 17, 120, 138, 139, 155, 151,168, 175, 179, 180, 181 and 185; Blue PB 15, 15:3, 15:4; Black PB 2, 5 and 7; carbon black; titanium dioxide (including rutile and anatase); zinc sulfide, and the like or a mixture thereof. Other specific pigments include, for example, IRGALITE BLUE GLVO, MONASTRAL BLUE FGX, IRGALITE BLUE GLSM, HELIOGEN BLUE L7101F, LUTETIA CYANINE ENJ, HELIOGEN BLUE L6700F, MONASTRAL GNXC, MONASTRAL GBX, MONASTRAL GLX, MONASTRAL 6Y, IRGAZIN DPP ORANGE RA, NOVAPERM ORANGE H5G70, NOVPERM ORANGE HL, MONOLITE ORANGE 2R, NOVAPERM RED HFG, HOSTAPERM ORANGE HGL, PALIOGEN ORANGE L2640, SICOFAST ORANGE 2953, IRGAZIN ORANGE 3GL, CHROMOPTHAL ORANGE GP, HOSTAPERM ORANGE GR, PV CARMINE HF4C, NOVAPERM RED F3RK 70, MONOLITE RED BR, IRGAZIN DPP RUBINE TR, IRGAZIN DPP SCARLET EK, RT-390-D SCARLET, RT-280-D RED, NOVAPERM RED HF4B, NOVAPERM RED HF3S, NOVAPERM RD HF2B, VYNAMON RED 3BFW, CHROMOPTHAL RED G, VYNAMON SCARLET 3Y, PALIOGEN RED L3585, NOVAPERM RED BL, PALIOGEN RED 3880 HD, HOSTAPERM P2GL, HOSTAPERM RED P3GL, HOSTAPERM RED E5B 02, SICOFAST RED L3550, SUNFAST MAGENTA 122, SUNFAST RED 122, SUNFAST VIOLET 19 228-0594, SUNFAST VIOLET 19 228-1220, CINQUASIA VIOLET RT-791-D, VIOLET R NRT-201-D, RED B NRT-796-D, VIOLET R RT-101-D, MONOLITE VIOLET 31, SUNFAST MAGENTA 22, MAGENTA RT-243-D, MAGENTA RT 355-D, RED B RT-195-D, CINQUASIA CARBERNET RT-385-D, MONOLITE VIOLET R, MICROSOL VIOLET R, CHROMOPTHAL VIOLET B, ORACET PINK RF, IRGALITE YELLOW 2GP, IRGALITE YELLOW WGP, PV FAST YELLOW HG, PV FAST YELLOW H3R, HOSTAPERM YELLOW H6G, PV FAST YELLOW, PALIOTOL YELLOW D1155 and IRGAZIN YELLOW 3R.

A number of different carbon black type pigments are commercially available, for example and carbon blacks such as SPECIAL BLACK 100, SPECIAL BLACK 250, SPECIAL BLACK 350, FW1, FW2 FW200, FW18, SPECIAL BLACK 4, NIPEX 150, NIPEX 160, NIPEX 180, SPECIAL BLACK 5, SPECIAL BLACK 6, PRINTEX 80, PRINTEX 90, PRINTEX 140, PRINTEX 150T, PRINTEX 200, PRINTEX U, and PRINTEX V, all available from Degussa Corporation (“Degussa”), MOGUL L, REGAL 400R, REGAL 330, and MONARCH 900, available from Cabot Chemical Co. (“Cabot”), MA77, MA7, MA8, MA11, MA10, MA100R, MA100S, MA230, MA220, MA200RB, MA14, #2700B, #2650, #2600, #2450B, #2400B, #2350, #2300, #2200B, #1000, #970, #3030B, and #3230B, all available from Mitsubishi Chemical Corporation (“Mitsubishi”), RAVEN 2500 ULTRA, Carbon black 5250, and Carbon Black 5750 from Columbia Chemical Co. (“Columbia”), and the like.

A number of titanium oxide pigments, including nanostructured titania powders, are also known and suitable for use herein. The titanium oxide particles can be coated with an oxide, such as alumina or silica, for example. One, two, or more layers of a metal oxide coating may be used, for example a coating of alumina and a coating of silica, in either order. In the alternative, or in addition, the titanium oxide particles may be surface treated with an organic compatibilization agent such as a zirconate, titanate, silanes, silicones, and the like.

If the colorant includes a pigment, the pigment is suitably pre-dispersed prior to incorporation into the ink composition, generally in one or more of the oligomer or monomer materials used in the composition. Generally, the pigment comprises about 5 to about 60% of the dispersion. A dispersant may also be included to improve the stability of the pigment dispersion and/or to substantially reduce or eliminate agglomeration or settling of the pigment particles during manufacture of the ink, storage, and/or use. The dispersant can be selected from a variety of materials including silicones, and other monomers or oligomers having good wetting properties for the pigment.

The pigments generally are of a size that can be jetted from a print head without substantially clogging print nozzles, capillaries, or other components of print equipment. Pigment size can also have an effect on the final ink viscosity. The average particle size of the pigment is about 10 to about 750 nanometers, specifically less than about 500 nanometers, and more specifically less than about 350 nanometers. For example, the pigments can have a D50 of less than or equal 350 nanometers.

The ink compositions exhibit a desirable combination of low viscosity in liquid form and enhanced elongation once cured, i.e., they have a viscosity at 25° C. of not greater than about 70 cPs, preferably not greater than 50 cPs, and even more preferably not greater than 35 cPs, and form a cured ink having an elongation of at least about 40% to about 150%. Generally, a cured ink exhibits no surface tack, as described in further detail below, when cured at a dose of 150 mJ/cm². Elongation is measured using an Instron tensile tester using a 100 Newton load cell and a crosshead speed of 300 mm/min. Samples are prepared on Scotchcal 220 vinyl (either draw downs as prepared in tests as described in the Examples below or by jetting). Strips of ¼″ width are cut and placed in the grips which are set 40 mm apart. The test is stopped when the vinyl breaks, the ink is observed to fracture on the vinyl, or the color of the ink is observed to fade/whiten. The percent elongation is then measured at the point where the test is stopped. Polycarbonate can also be used as the substrate in testing elongation if the Instron tester is equipped with an oven. Once the ink/polycarbonate sample is placed in the grips, the sample needs to be heated to 150° C. to soften the polycarbonate and allow it to be easily stretched. Viscosity may be measured using a Haake RV-1 rheometer with a C60/2 sensor and a TCP/P—Peltier Temperature Control Unit at 25° C. at a shear rate of 500 s⁻¹. In a more specific embodiment, the compositions have a viscosity at 25° C. of not greater than about 70 cPs, or, more specifically, not greater than about 50 cPs or even more specifically, not greater than 35 cPs.

The proportions of the monofunctional monomer and polyfunctional components described above can be controlled to obtain properties in combination with a colorant. In a more specific embodiment, the ink compositions comprise, based on the total weight of the ink, from about 5 to about 65 wt. % , preferably about 10 to about 50 wt. %, and more preferably about 10 to about 30 wt. % of the polyfunctional component, and from about 1 to about 80 wt. %, preferably about 5 to about 70 wt. %, and preferably about 15 to about 70 wt. %, of the monofunctional monomer. In one embodiment, the amount of monofunctional monomer is greater than 55 wt. %, preferably greater than 60 wt. % and the ink composition is substantially free of tri- or higher functional monomer.

In some embodiments containing the optional monofunctional component, and/or chain transfer agent, the compositions may comprise from 0 to about 50 wt. %, preferably about 5 to about 50 wt. %, and preferably about 10 to about 40 wt. %, of the ethylenically unsaturated monofunctional oligomer and/or from about 0 to about 25 wt. %, preferably about 1 to about 25 wt. % of the chain transfer agent.

In alternate embodiments, the compositions may comprise from about 5 to about 30 wt. % of the ethylenically unsaturated polyfunctional oligomer, from about 1 to about 80 wt. % of the monofunctional monomer, from about 0 to about 25 wt. % of the monofunctional component, and from about 0 to about 25 wt. % of the chain transfer agent. In another embodiment, the compositions may comprise from about 7 to about 25 wt. % of the ethylenically unsaturated polyfunctional oligomer, from about 5 to about 70 wt. % of the monofunctional monomer, from about 0 to about 25 wt. % of the monofunctional component, and from about 0 to about 25 wt. % of the chain transfer agent. In general, the colorant is used in an amount of about 0.01 to 25 wt. %, specifically about 0.05 to about 10 wt. %, and more specifically about 0.05 to about 7.5 wt. % of the total weight of the ink composition.

Optionally, colorant may be excluded from the compositions as described herein, wherein a colorless coating composition is formed. All of the disclosure set forth herein relating to the ink compositions, other than the colorant descriptions, is equally applicable to such colorless coating compositions.

In additional embodiments, the ink compositions preferably exhibit a surface tension such that the composition jets well and adequately wets out the substrate. In a specific embodiment, the ink compositions exhibit a surface tension of less than about 40 dynes/cm, more specifically less than about 36 dynes/cm, at 25° C.

The radiation curable ink compositions may also contain a polymerization initiator. Various photoinitiators are known in the art and may be selected based on the type of colorant present and the radiation wavelength used to cure the ink. A blend of photoinitiators can be used, having peak energy absorption levels at varying wavelengths within the range of the selected radiation for cure. Preferably, the photoinitiator and photoinitiator blends are sensitive to the wavelengths not absorbed, or only partially affected, by the pigment and/or dye colorant.

Examples of suitable photoinitiators include 2-benzyl-2-(dimethylamino)-4′-morpholinobutyrophenone; 2-hydroxy-2-methylpropiophenone; trimethylbenzophenone; methylbenzophenone; 1-hydroxycyclohexylphenyl ketone; isopropyl thioxanthone; 2,2-dimethyl-2-hydroxy-acetophenone; 2,2-dimethoxy-2-phenylacetophenone; 2-methyl-1-[4-(methylthio)phenyl]-2-morpholino-propan-1-one; 2,4,6-trimethylbenzyl-diphenyl-phosphine oxide; 1-chloro-4-propoxythioxanthone; benzophenone; bis(2,6-dimethoxybenzoyl)-2,4,4-trimethyl pentyl phosphine oxide; 1-phenyl-2-hydroxy-2-methyl propanone; bis(2,4,6-trimethylbenzoyl)phenylphosphine oxide; camphorquinone; and the like. Combinations comprising one or more of the foregoing may also be used. Suitable commercially available photoinitiators include, but are not limited to Irgacure 907, Irgacure 819, Irgacure 2100, Irgacure 2959, Irgacure 184, Irgacure 369, Irgacure 379, Irgacure 651 and Darocur 1173, Darocur TPO, and Darocur MBF, commercially available from Ciba Specialty Chemicals (“Ciba”) benzophenone, Genocure LBP, available from Rahn, ITX SarCure SR1124 and TZT SarCure SR1137, commercially available from Sartomer, Chivacure BMS, commercially available from Chitec Technology Co., and combinations thereof.

The polymerization initiators are used in amounts effective to initiate polymerization in the presence of the curing radiation, typically about 3 to about 25 wt. %, specifically about 5 to about 20 wt. %, and more specifically about 5 to about 15 wt. %, and more specifically, about 7 to about 15 wt. %, based on the total weight of the ink.

The photoinitiator composition can further contain a coinitiator for example, an amine coinitiator such as, for example, ethyl-4-(dimethylamino)benzoate, 2-ethylhexyl dimethylaminobenzoate, dimethylaminoethyl(meth)acrylate, or the like. Reactive amine polymerization coinitiators can be used, such as the coinitiator CN386 (a reactive amine adduct of tripropylene glycol diacrylate), commercially available from Sartomer, Darocure EHA, commercially available from Ciba, commercially available from Rahn, and the like. The coinitiator can be present in the ink in an amount of about 0.25 to about 20 wt. %, specifically about 1 to about 10 wt. %, and more specifically about 2 to about 7 wt. %, based on the total weight of the ink.

The ink compositions can also include, as additives, an ultraviolet light absorbing material (“UVA”) and/or a hindered amine light stabilizer (“HALS”) to provide photolytic stability to the ink. The UVA and or HALS can be added to the ink composition to improve the weatherability of the cured ink. These additives provide the retention of color through the lifetime of the cured ink. Commercial versions of UVAs include, but are not limited to Tinuvin 384-2, Tinuvin 1130, Tinuvin 405, Tinuvin 411L, Tinuvin 171, Tinuvin 400, Tinuvin 928, Tinuvin 99, combinations thereof, and the like. Commercially available examples of HALS include, but are not limited to Tinuvin 123, Tinuvin 292, Tinuvin 144, Tinuvin 152, combinations thereof, and the like. There are available as well combinations of UVA and HALS materials, useful in radiation curable inks, and commercially available as Tinuvin 5055, Tinuvin 5050, Tinuvin 5060, Tinuvin 5151. All Tinuvin products are commercially available from Ciba. It should be recognized that this list of compounds is exemplary and should not be considered as limited thereto.

Other additives can be included in the radiation curable ink compositions, including stabilizers, antioxidants, surfactants, and additional dispersion agents. When used, the stabilizers can be present in the ink in an amount of about 0.001 to about 2 wt. %, specifically about 0.01 to about 0.5 wt. %, and more specifically about 0.1 to about 0.3 wt. %, based on the total weight of the ink. Commercially available stabilizers include I-1035, commercially available from Ciba, and MEHQ (4-methoxyphenol), HQ (hydroquinone) and BHT (butylated hydroxyl toluene) commercially available from Sigma-Aldrich Corp, and G-1402 and G-16 commercially available from Rahn.

Surfactants can be used to adjust the surface tension of the ink to aid in wetting out low surface energy substrates. Wetting occurs where the adhesive forces between the ink and substrate are stronger than the cohesive forces of the ink. Without being bound by theory, it is believed that non-wetting performance, such as beading and contracting, correlates to stronger cohesive forces in the ink than adhesive forces between the ink and the substrate. Beading occurs where the ink, after application, forms a string of disconnected droplets instead of remaining a uniform coat as applied, and contracting occurs where the ink shrinks from the furthest extent of its initial application to a surface.

Surfactants suitable for use in the inks include, but are not limited to, polysiloxanes, polyacrylic copolymers, fluorine containing polymers, and the like. In a specific embodiment, these materials contain reactive groups that allow them to become part of the cured network. Suitable examples include Rad 2100, Rad 2200, Rad 2250, Rad 2300, Rad 2500, Rad 2600, and Rad 2700 commercially available from Degussa; CoatOSil 1211, CoatOSil 1301, CoatOSil 3500, CoatOSil 3503, CoatOSil 3509, and CoatOSil 3573 commercially available from GE Silicones; Byk-381, Byk-333, Byk-377, Byk-UV 3500, Byk-UV 3510, and Byk-UV 3530 commercially available from Byk Chemie; and FC-4430 and FC-4432 commercially available from 3M Corporation. An effective amount of surfactant where used, is from about 0.01 to about 2 wt. %, specifically about 0.05 to about 1.5 wt. %, more specifically about 0.1 to about 1 wt. %, of the total weight of the ink composition.

The ink compositions of the invention are suitable for use in printing on various substrates, including polymers, cellulose substrates, including paper, and the like. Advantageously, the ink compositions are jettable from a variety of known inkjet print heads, whereby the inks are suitable for use in methods comprising the steps of jetting the ink onto a substrate to form a curable ink printed feature; and curing the ink printed feature. Conventional curing conditions may be employed and typically provide a tack-free surface. Suitably, the ink compositions are curable at for example 100, 150, 200, 700, 1000 or 1500 mJ/cm², or lower or higher levels as desired. The cured ink has an elongation of at least 40%, and in specific embodiments, at least 60%. Thus, the cured printed feature is suitable for applications requiring flexibility wherein the printed feature on the substrate may be stretched at a temperature at or above the glass transition temperature (Tg) of the substrate. Thus, in a specific embodiment, the cured ink composition has a Tg of at least 0° C. In another specific embodiment, the cured ink is suitable for applications such as signage.

The following examples demonstrate various embodiments of the invention. Ink compositions are prepared, for example, by blending to form a homogeneous solution and filtering. Other techniques known in the art may also be employed. Unless otherwise specified, parts and percentages within the examples and the specification refer to parts by weight and percentages by weight, respectively.

### EXAMPLES

Elongation is measured in accordance with the procedure described above. The following additional procedures and techniques employed in the Examples are described below.

Crosshatch adhesion was determined according to the following procedure: A film of an inkjet ink was prepared at a thickness of 9 micrometers using a #6 Mayer rod on the substrate indicated, cured using a mercury vapor lamp at a dose of 700 mJ/cm², and conditioned for 16-24 hours at 25° C. (±2° C.) at a relative humidity of 50% (±5%). A series of 6 parallel incisions of 2 to 2.5 cm in length and spaced 2.0 mm apart was made in the film using a suitable cutting tool such as a Gardco PA-2000 cutting tool with 6 parallel blades, followed by a second set of incisions of the same dimensions, rotated 90° to the first set forming a crosshatch pattern. The crosshatched surface was cleaned using a brush or compressed air to remove particulate contaminants. A length of 7 to 8 cm of a suitable tape, such as 3M 610 tape, available from 3M Corporation, was applied to the crosshatched area and rubbed smoothed to remove any trapped air bubbles and to ensure a good contact. The tape was then pulled off within 90 seconds (±30 seconds) upon application to the crosshatched area. The crosshatch areas were then quantified according to the method of ASTM D3359.

MEK Rub test: The MEK (methyl ethyl ketone) rub technique is a method for assessing the solvent resistance of a cured inkjet ink by incorporating ASTM D4752 into ASTM D3732-82. The ink to be cured was applied to a polyester (“PET”), polycarbonate (“PC”) or vinyl substrate using #6 Mayer Rod. The coated film was cured using a Hanovia mercury vapor lamp (part No. 6812A431, max power 300 Watts/inch) at a dose of 700 mJ/cm² (dosage recorded by an IL390C radiometer from International Light). Test areas on the ink film surface of at least 2 inches long were selected for testing. The ball end of a hammer wrapped in two thicknesses of cheesecloth is saturated to a dripping wet condition with MEK. The wet ball end was rubbed across the 2-inch portion of the cured film, one forward and one backward movement constitutes a single rub. The surface is rubbed until the ink has been completely removed from any point along the test area or after 200 MEK rubs, whichever comes first. The number of rubs required to expose the substrate was recorded.

Degree of cure: The degree of cure of the ink was determined by measuring percent reacted acrylate unsaturation (“% RAU”) of the cured ink using a Nicolet 860 Magna FT-IR bench equipped with a Durasampl IR II ATR (Diamond). A drop of liquid inkjet ink was placed onto the diamond ATR crystal and a spectrum of the unreacted liquid ink was obtained. A cured film of ink was prepared for spectral analysis by forming a film of ink having a thickness of about 7-10 micrometers using #6 Mayer rod drawdown over a polyethylene terephthalate (“PET”) substrate. The ink film was then cured using the described Hanovia mercury vapor lamp, at a specified dose. The cured ink film was removed from the substrate and the top surface and the bottom surface of the film (the face adjacent to the substrate) were measured for degree of cure. The degree of cure at the top surface of the film (“TOP RAU %”) was determined by cutting a piece of ink film (about ½″×½″) and having the top surface of the film face the diamond ATR crystal while a spectrum was obtained. The degree of cure at the face of the film opposite to the surface (Bottom RAU %) was obtained by facing the bottom surface of the film to the diamond ATR crystal while a spectrum was obtained. The carbon-carbon bond of the acrylate functionality was observed in the cured ink at about 1410 cm⁻¹.

Static and Kinetic coefficient of friction (COF): The COF was determined via Instron. The inks were cured over flexible Scotchcal 220 vinyl at 250 mJ/cm², using the Fusion curing unit under the H lamp. The cured films were placed on a horizontal platform and were taped with a scotch tape. With a 100 Newton load cell at 200.7 gram force of a square bar tape with the backside of the vinyl was allowed to slide at a rate of 100 millimeters/minute over a 5 centimeter length. The respective static and kinetic coefficient of friction values were recorded. A blank test involving vinyl substrate was also run as a control. In one embodiment the static COF of the cured ink composition of the invention is less than about 0.7 and the kinetic COF is less than about 0.4.

### Example 1

This Example 1, demonstrates monofunctional monomer based cyan ink compositions with a polyfunctional component, in combination with the optional monofunctional oligomer. The ink compositions all exhibit viscosities at 25° C. below 35 cP, and the cured file exhibits elongation of 109% and above. Ink compositions are provided in Table 1A and ink properties are provided in Table 1B

TABLE 1A
Ink Compositions

| Raw Material | 1A | 1B | 1C | 1D | 1E |
|---|---|---|---|---|---|
| SR 285 | 24.30 | 24.03 | 24.30 | 24.03 | 22.64 |
| SR 395 | 12.89 | 13.01 | 12.89 | 13.01 | 12.80 |
| CN966H90 | 1.98 | 2.00 | 0.00 | 0.00 | 0.00 |
| SR 9035 | 9.92 | 10.01 | 11.90 | 12.01 | 11.86 |
| CN3100 | 13.88 | 14.02 | 13.88 | 14.02 | 13.78 |
| CN 386 | 4.36 | 3.40 | 4.36 | 3.40 | 4.34 |
| I-1035 | 0.99 | 1.00 | 0.99 | 1.00 | 0.99 |
| I-369 | 3.47 | 3.50 | 3.47 | 3.50 | 3.44 |
| D-1173 | 2.98 | 3.00 | 2.98 | 3.00 | 2.95 |
| TZT | 2.48 | 2.50 | 2.48 | 2.50 | 2.47 |
| HQ | 0.10 | 0.10 | 0.10 | 0.10 | 0.99 |
| I-184 | 0.92 | 0.93 | 0.92 | 0.93 | 0.92 |
| Darocur MBF | 2.48 | 1.50 | 2.48 | 1.50 | 2.47 |
| ITX | 0.40 | 0.46 | 0.40 | 0.46 | 0.39 |
| EB 1360 | 3.97 | 4.00 | 3.97 | 4.00 | 4.98 |
| V-cap | | 1.50 | | 1.50 | |
| Cyan | 14.88 | 15.02 | 14.88 | 15.02 | 14.97 |
| Dispersion | | | | | |
| (20% in SR | | | | | |
| 256) | | | | | |
| MN-B14104 | | | | | |
| Total | 100.00 | 100.00 | 100.00 | 100.00 | 100.00 |

TABLE 1B
Ink Properties

| Testing | 1A | 1B | 1C | 1D | 1E |
|---|---|---|---|---|---|
| Ink Viscosity at 25° C., | 29.95 | 31.1 | 23.44 | 27.1 | 28.36 |
| Haake, 500 sec⁻¹ | | | | | |
| (cP) | | | | | |
| Initial Cure at 700 | Cured | Cured | Cured | Cured | Cured |
| mJ/cm2, H, Hanovia, | | | | | |
| #12 rod | | | | | |
| % Elongation at 25 C. | 138.6 | 136.0 | 122.9 | 108.8 | 119.86 |

### Example 2

This Example 2, demonstrates monofunctional monomer based ink compositions with polyfunctional components CN966H90, and SR9035, which is an alkoxylated trimethylolpropane tri-acrylate polyfunctional monomer commercially available from Sartomer. The ink compositions all exhibit viscosities at 25° C. below 70 cP, and the cured file exhibits elongation of 109% and above. Ink compositions are provided in Table 2A and ink properties are provided in Table 2B.

TABLE 2A
Ink Compositions

| Raw Material | 2A | 2B | 2C | 2D |
|---|---|---|---|---|
| CN966H90 | 10.00 | 10.00 | 10.00 | 10.00 |
| SR9035 | 28.80 | 28.80 | 28.80 | 28.80 |
| SR 256 | 4.00 | 4.00 | 4.00 | 4.00 |
| SR285 | 15.00 | 15.00 | 15.00 | 15.00 |
| SR395 | 15.00 | 15.00 | 15.00 | 15.00 |
| Darocur 1173 | 3.20 | 3.20 | 3.20 | 3.20 |
| Irgacure 379 | 3.70 | 3.70 | 3.70 | 3.70 |
| TZT | 2.80 | 2.80 | 2.80 | 2.80 |
| ITX | 0.50 | 0.50 | 0.50 | 0.50 |
| Irgacure 184 | 1.00 | 1.00 | 1.00 | 1.00 |
| Irganox 1035 | 1.00 | 1.00 | 1.00 | 1.00 |
| Cyan Dispersion (20% in TPGDA) | 15.00 | | | |
| NN-BBD15-1 | | | | |
| Magenta Dispersion (20% in | | 15.00 | | |
| TPGDA) NN-MCC08-1 | | | | |
| Yellow Dispersion (20% in | | | 15.00 | |
| TPGDA) NN-YDF09-1 | | | | |
| Black Dispersion (20% in TPGDA) | | | | 15.00 |
| NN-KAA07-1 | | | | |
| Total | 100.00 | 100.00 | 100.00 | 100.00 |

TABLE 2B
Ink Properties

| Testing | | 2A | 2B | 2C | 2D |
|---|---|---|---|---|---|
| Ink Viscosity at 25° C., | | 63.52 | 67.76 | 63.80 | 60.60 |
| Haake, 500 sec⁻¹ (cP) | | | | | |
| Crosshatch Adhesion, #12 rod, | Vinyl | 5B | 5B | 5B | 0B |
| H, Hg vapor, 700 mJ/cm2 | PC | 5B | 5B | 5B | 2B |
| | PET | 0B | 0B | 0B | 0B |
| % Elongation | Vinyl | 71.6 | 74.3 | 79.2 | 61.6 |
| MEK Double Rubs, #12 rod, | Vinyl | 20 | 20 | 22 | 1 |
| H, Hg vapor, 700 mJ/cm2 | PC | 1 | 1 | 1 | 1 |
| | PET | 1 | 3 | 2 | 1 |

### Example 3

This Example 3, demonstrates monofunctional acrylate monomer based clear ink compositions with polyfunctional components, and containing a chain transfer agent. The ink compositions all exhibit viscosities at 25° C. of less than 70 cP, and the cured file exhibits elongation of up to 130% on vinyl substrate. Ink compositions are provided in Table 3A and ink properties are provided in Table 3B.

TABLE 3A
Ink Compositions

| Raw Material | 3A | 3B | 3C | 3D | 3E |
|---|---|---|---|---|---|
| CN966H90 | 10.00 | 10.00 | 10.00 | 10.00 | 10.00 |
| SR9035 | 52.00 | 51.00 | 49.00 | 46.00 | 43.00 |
| SR256 | 4.00 | 4.00 | 4.00 | 4.00 | 4.00 |
| SR285 | 15.00 | 15.00 | 14.00 | 13.00 | 12.00 |
| SR395 | 15.00 | 15.00 | 14.00 | 13.00 | 12.00 |
| Darocur 1173 | 4.00 | 4.00 | 4.00 | 4.00 | 4.00 |
| IOMP | | 1.00 | 5.00 | 1.00 | 15.00 |
| Total | 100.00 | 100.00 | 100.00 | 91.00 | 100.00 |

TABLE 3B
Ink Properties

| Testing | | 3A | 3B | 3C | 3D | 3E |
|---|---|---|---|---|---|---|
| Ink Viscosity at 25° C., | | 68.1 | 68.1 | 54.9 | 45.8 | 48.7 |
| Haake, 500 sec⁻¹ (cP) | | | | | | |
| Crosshatch Adhesion, #12 | Vinyl | 5B | 5B | 5B | 5B | 5B |
| rod, Hg vapor, H, | | | | | | |
| 700 mJ/cm2 | | | | | | |
| % Elongation | Vinyl | 63 | 64 | 72 | 96 | 127 |
| MEK Double Rubs, #12 rod, | Vinyl | 12 | 11 | 7 | 3 | 0 |
| Hg vapor, H, 700 mJ/cm2 | | | | | | |

### Example 4

This Example 4, demonstrates cyan ink compositions with the polyfunctional component being a di-functional monomer and including a chain transfer agent containing an acetoacetic ester moiety. The ink compositions all exhibit viscosities at 25° C. of less than 60 cP, and the cured file exhibits elongation of up to about 99% on vinyl substrate. Ink compositions are provided in Table 4A and ink properties are provided in Table 4B.

TABLE 4A
Ink Compositions

| Raw Material | 4A | 4B | 4C |
|---|---|---|---|
| CN966H90 | 12.00 | 16.50 | 25.00 |
| SR395 | 7.00 | | 27.00 |
| SR285 | 11.50 | | 10.00 |
| VEEA | 40.00 | 44.68 | 7.60 |
| TMPTAA | 10.00 | | |
| Isopropyl acetoacetic ester | | 5.50 | 7.50 |
| CN 386 | | 6.50 | 3.00 |
| LBP | | | 1.50 |
| MBF | | 3.00 | |
| Irgacure 2100 | | | 3.50 |
| Irganox 1035 | | 0.90 | 0.91 |
| TZT | | 2.50 | |
| HQ | | 0.09 | 0.09 |
| I 184 | | 0.93 | |
| Darocur 1173 | 3.50 | 3.00 | |
| Irgacure 369 | 3.00 | 3.50 | 1.00 |
| ITX | 0.50 | 0.40 | 0.40 |
| Cyan Dispersion (20% in TPGDA) | 12.50 | 12.50 | 12.50 |
| NN-BBD15-1 | | | |
| Total | 100.00 | 100.00 | 100.00 |

TABLE 4B
Ink Properties

| Testing | | 4A | 4B | 4C |
|---|---|---|---|---|
| Ink Viscosity at 25° C., Haake, | | 28.7 | 37.3 | 57.5 |
| 500 sec⁻¹ (cP) | | | | |
| D Bulb 700 mJ/cm² | | | | |
| Initial Cure | Vinyl | Cured | Cured | Cured |
| Cross Hatch | PC | 5B | NA | NA |
| MEK Double Rubs | PC | 1 | NA | NA |
| % Elongation | Vinyl | 70 | 57 | 99 |

### Example 5

This Example 5, demonstrates ink compositions with the pigment dispersions in monofunctional monomer and further containing a polyfunctional component. The cured compositions exhibited 5B adhesion, and showed some degree of crosslinking as measured by MEK rubs. The inks had a jettable viscosity and exhibited elongation of up to 90%. The ink when cured exhibits a low COF, as measured by Instron. Ink compositions are provided in Table 5A and ink properties are provided in Table 5B.

TABLE 5A
Ink Compositions

| | 5A | 5B | 5C | 5D | 5E |
|---|---|---|---|---|---|
| Raw Material | Cyan | Magenta | Yellow | Black | Black |
| CN 9893 | 4.00 | 4.00 | 4.00 | 4.00 | 2.50 |
| CN 386 | 3.50 | 3.00 | 3.50 | 3.50 | |
| SR 395 | | | | | 5.00 |
| SR506 | 40.95 | 40.00 | 40.95 | 40.95 | 32.19 |
| EB1290 | 15.00 | 14.45 | 15.00 | 15.00 | 10.00 |
| TegoRad 2300 | 1.00 | 1.00 | 1.00 | 1.00 | 1.00 |
| Darocur TPO | 3.00 | 3.00 | 3.00 | 3.00 | 3.00 |
| Irgacure 907 | 6.00 | 6.00 | 6.00 | 6.00 | 6.00 |
| ITX | 1.50 | 1.50 | 1.50 | 1.50 | 1.50 |
| MEHQ | 0.05 | 0.05 | 0.05 | 0.05 | 0.05 |
| Genocure LBP | | | | | 3.00 |
| V-Cap | | | | | 25.00 |
| V-Pyrol | 15.00 | 15.00 | 15.00 | 1500 | |
| Cyan Dispersion, 20% in 2-PEA | 10.00 | | | | |
| Magenta Dispersion, 17-20% in 2-PEA | | 12.00 | | | |
| Yellow Dispersion, 20% in 2-PEA | | | 10.00 | | |
| Black Dispersion, 20% in 2-PEA | | | | 10.00 | 10.76 |
| Total | 100.000 | 100.000 | 100.000 | 100.000 | 100.000 |

TABLE 5B
Ink Properties

| | 5A | 5B | 5C | 5D | 5E |
|---|---|---|---|---|---|
| Properties | Cyan | Magenta | Yellow | Black | Black |
| Viscosity @ 25 C. | 31.8 | 29.7 | 30.8 | 29.8 | 22.8 |
| Viscosity after aging for 4 weeks at 60 C. | 33.8 | 32.7 | 32.9 | 32.8 | |
| Surface Tension at 1000 msecs, Kruss | 24.7 | 24.6 | 24.6 | 24.9 | |
| Initial Cure (i.e. are the films tacky, thumb | Cured | Cured | Cured | Cured | Cured |
| test), 150 mJ/cm2, H, Hg Vapor Bulb | | | | | |
| Static COF of ink | 0.26 | 0.19 | 0.18 | 0.21 | |
| Kinetic COF of ink | 0.1 | 0.09 | 0.08 | 0.08 | |
| Opacity over Leneta Chart, 150 mJ/cm2, | 18.9 | 19 | 8 | 86.4 | |
| Fusion, H | | | | | |
| % Elongation at 50 C. | 78.7 | 75.3 | 88.5 | 67.6 | 86.0 |
| Adhesion over Vinyl | 49 | 49 | 49 | 49 | |
| MEK rubs over Vinyl | 4 | 6 | 5 | 5 | |
| Adhesion over PET | 44 | 49 | 49 | 4 | |
| MEK rubs over PET | 8 | 7 | 9 | 7 | |
| Adhesion over PC | 6 | 12 | 26 | 15 | |
| MEK rubs over PC | 5 | 11 | 7 | 9 | |
| FTIR % Cure Top on PET @ 150 mJ/cm2, | No peak | No peak | No peak | No | |
| Fusion, Hg Vapor bulb, 1410 cm⁻¹ | | | | peak | |
| FTIR % Cure Bottom on PET @ 150 mJ/cm2, | Cannot | Cannot | Cannot | 96.7% | |
| Fusion, Hg Vapor bulb, 1410 cm⁻¹ | Determine | Determine | Determine | | |

The specific illustrations and embodiments described herein are exemplary only in nature and are not intended to be limiting of the invention defined by the claims. Further embodiments and examples will be apparent to one of ordinary skill in the art in view of this specification and are within the scope of the claimed invention.

We Claim:

1. A radiation curable and jettable ink composition comprising:
a ethylenically unsaturated polyfunctional component;
an ethylenically unsaturated monofunctional monomer; and
optionally an additional monofunctional component or chain transfer agent;
wherein the composition is substantially free of solvent, has a viscosity at 25° C. of not greater than about 70 cPs and, when cured by radiation, provides a cured film having an elongation of at least about 40% to about 150%.

2. The ink composition of claim 1, having a viscosity at 25° C. of not greater than about 50 cPs.

3. The ink composition of claim 1 comprising from about 5 to about 65 wt. % of the polyfunctional component, from about 1 to about 80 wt. % of the monofunctional monomer, from 0 to about 50 wt. % of the ethylenically unsaturated monofunctional oligomer and from about 0 to about 25 wt. %.

4. The ink composition of claim 1 comprising from about 10 to about 50 wt. % of the ethylenically unsaturated polyfunctional component, from about 1 to about 80 wt. % of the monofunctional monomer, from about 0 to about 50 wt. % of the monofunctional component, and from about 0 to about 25 wt. % of the chain transfer agent.

5. The ink composition of claim 1 comprising from about 10 to about 30 wt. % of the ethylenically unsaturated polyfunctional component, from about 1 to about 80 wt. % of the monofunctional monomer, from about 0 to about 50 wt. % of the monofunctional component, and from about 0 to about 25 wt. % of the chain transfer agent.

6. The ink composition of claim 1, wherein the ethylenically unsaturated polyfunctional component comprises ethylenically unsaturated oligomers, monomers and combinations thereof.

7. The ink composition of claim. 6 wherein the ethylenically unsaturated polyfunctional component comprises an ethylenically unsaturated oligomer.

8. The ink composition of claim 7, wherein the ethylenically unsaturated oligomer comprises a hexa-functional aliphatic urethane oligomer.

9. The ink composition of claim 8, wherein the ethylenically unsaturated oligomer further comprises a di-functional urethane oligomer.

10. The ink composition of claim 9, wherein the ethylenically unsaturated oligomer further comprises an amine di-acrylate oligomer.

11. The ink composition of claim 1, wherein the ethylenically unsaturated monofunctional monomer comprises a monofunctional acrylate monomer or a monofunctional acrylate monomer containing a cyclic group, wherein the cyclic group is aliphatic or aromatic and may contain one or more homo or heterocyclic ring structures.

12. The ink composition of claim 11, wherein the monofunctional acrylate monomer comprises isobornyl acrylate.

13. The ink composition of claim 1 the chain transfer agent is present and is selected from an acetoacetate, a thiol, an amine, a mercapto-modified silicone, and combinations thereof.

14. The ink composition of claim 1, wherein the composition is a cured composition and the cured composition has a static coefficient of friction of less than about 0.7 and a kinetic coefficient of friction of less than about 0.4.

15. The ink composition of claim 1, wherein the ink is cured at a dose of 150 mJ/cm² to obtain a tack free surface.

16. The ink composition of claim 1 wherein the composition is substantially free of non-reactive oligomers.

17. A radiation curable and jettable ink composition comprising:
a ethylenically unsaturated polyfunctional component;
at least 1 wt. % monofunctional acrylate;
a colorant; and
optionally an additional ethylenically unsaturated monofunctional component or chain transfer agent;
wherein the composition is substantially free of solvent, has a viscosity at 25° C. of not greater than about 70 cPs and, when cured by radiation, forms a cured film having an elongation of at least about 40% to about 150%.

18. The radiation curable and jettable ink composition of claim 17 wherein the polyfunctional component comprises an alkoxylated trimethylolpropane tri-acrylate monomer.

19. The radiation curable and jettable ink composition of claim 17 further comprising at least one photoinitiator.

20. The radiation curable and jettable ink composition of claim 17 having a viscosity at 25° C. of not greater than about 35 cPs.

21. A process for preparing a printed article comprising contacting a substrate with the ink composition of claim 1.

22. An article comprising a substrate and the cured ink composition of claim 1.
